(19) United States
(12) Patent Application Publication
(10) Pub. No.: US 2004/0103571 A1
(43) Pub. Date: Jun. 3, 2004

(54) Concept of, method of, and tool; motor coach billboard sales and advertisement

(76) Inventor: Miranda Music Smith, Brunswick, GA (US)

Correspondence Address: Miranda M. Smith, 153 Shadow Lake Dr., Brunswick, GA, 31525, US

(21) Appl. No.: 10/308,047

(22) Filed: Dec. 3, 2002

(51) Int. Cl. G09F 21/04

(52) U.S. Cl. 40/591

(57) ABSTRACT

An inexpensive method of promotional advertising with marketing that targets individuals and groups of people around the country; during small and large show events.

The tool creates housing and mobile advertisement.

### SUMMARY

By using a motor coach exterior to create a billboard of numerous spaces for advertisement, allows for sales or barter to be written to companies or individuals whom want to advertise a product or other, in numerous locations for one low cost.

### DESCRIPTION OF DRAWINGS

FIG. 1 is a perspective front and side view of the tool used to market advertisement space to companies or individuals, and how the spaces are displayed.

### DETAILED DESCRIPTION

There are structural similarities between class A, class C, and luxury motor coaches. The construction outward from the studs typically consists of fiberglass or aluminum. For simplicity's sake, the descriptions that follow should be construed as applicable to class A, class C, and luxury motor coaches. The invention herein described is therefore not limited to motor coaches of one class. However, the invention does not pertain to those motor coaches used as personal or business advertising. Referring now to the figure, in which like numerals are used to depict like elements in all drawings, the present invention is described as follows:

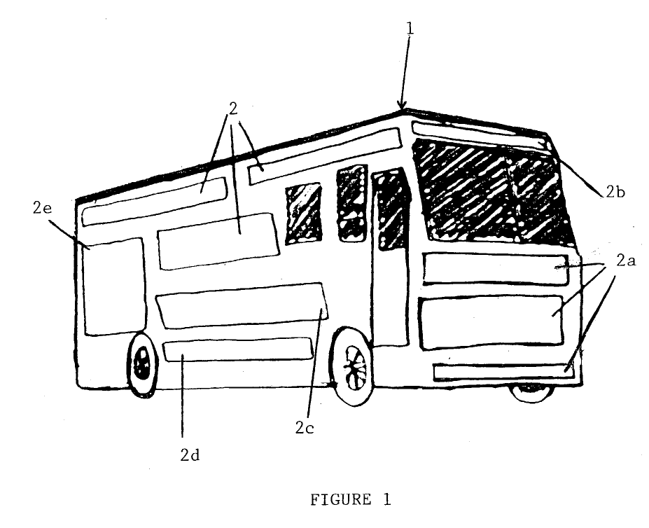

FIG. 1 depicts a front and side view of the tool (1) used to market advertisement spaces to companies. It comprises of certain square footage per ad space, with number of spaces depending on size of motor coach. The ad (2) is typically affixed by vinyl graphics (2a), painted art (2b), light board graphics (2c), magnetic lettering (2d), computer or video monitor graphics (2e). The application of which would depend on term of advertisement. (Term being daily, weekly, monthly, yearly, or negotiated upon.) The possible number of spaces allowed would depend on exterior size and structure of motor coach. Advertisement spaces would be sold for monetary units, or be bartered for items or promotions of equal trade value. These motor coach billboards will travel the United States year round for shows, festivals and special events, which will benefit the advertising clients. A group of persons will accompany each motor coach to promote for the advertising clients.

I claim:

1. A method of motor coach advertising will increase customer traffic and expand customer knowledge of companies and products advertised.

2. the method of claim 1 wherein:
Providing advertisement spaces for sale, trade, or barter to companies on a motor coach is a viable form of advertising.

3. A structure exterior advertising tool, comprising:
A class “A” motor coach
A class “C” motor coach
A “luxury” class motor coach

4. method of claim 1 wherein:
said fastening of advertisement by vinyl graphics,
said fastening of advertisement by paint,
said fastening of advertisement by magnetic sign,
said fastening of advertisement by affixed light board,
said fastening of advertisement by affixed computer or video screen,

5. Providing motor coach billboards is a profitable and long term business.
